(19) United States
(12) Patent Application Publication
(10) Pub. No.: US 2022/0235919 A1
(43) Pub. Date: Jul. 28, 2022

(54) TEMPORARY-TO-PERMANENT LIGHTING SYSTEM

(71) Applicant: IES Residential, Inc., Stafford, TX (US)

(72) Inventor: Christopher Todd BRUNNER, Houston, TX (US)

(21) Appl. No.: 17/580,895

(22) Filed: Jan. 21, 2022

Related U.S. Application Data
(60) Provisional application No. 63/142,356, filed on Jan. 27, 2021.

(51) Int. Cl. F21V 17/12; F21V 23/00; F21V 23/06

(52) U.S. Cl. CPC F21V 17/12; F21V 23/06; F21V 23/001

(57) ABSTRACT

Temporary-to-permanent lighting systems and methods of utilization thereof include: connecting a light source to a permanent wiring system of a construction project; connecting a protective cover to the light source; and after the light source has been utilized to provide a first specified illumination during stages of the construction project, connecting a cover plate to the light source, wherein the light source remains connected to the permanent wiring system during the stages of the construction project and while connecting the cover plate to the light source. Systems also include a light source configured to fasten to an electrical outlet box of a permanent wiring system; a protective cover configured to connect to the light source with one or more first quick-connect fastening mechanisms; and a cover plate configured to connect to the light source with one or more second quick-connect fastening mechanisms.

### CROSS REFERENCE TO RELATED APPLICATIONS

This application claims benefit of U.S. Provisional Patent Application Ser. No. 63/142,356, filed Jan. 27, 2021, entitled “Temporary-To-Permanent Lighting System,” which is incorporated herein by reference in its entirety.

### BACKGROUND

This disclosure generally relates to the field of electrical wiring installations. Electrical wiring can include, for example, metallic, and/or fiber optic cabling, among others. This disclosure may have applications in the installation and/or finishing of electrical systems, for example, for new construction and/or renovation projects, such as for multifamily residential housing.

On construction sites, regulations such as OSHA Standard CFR 1926.56(a) typically require specific minimum illumination intensities for general construction areas, ramps, runways, corridors, etc. (e.g., at least 5 foot-candles for general construction, or at least 10 foot-candles for in plants or shops). In dim areas where sufficient ambient light (e.g., sunlight) is unavailable during construction, minimum illumination requirements are typically met through installation of temporary lighting systems (e.g., temporary light strings). As a standard industry practice, the responsibility for temporary lighting provision is often placed on electrical contractors. To meet regulatory standards, the electrical contractors typically install the temporary lighting systems as early as possible during the construction project. The temporary lighting systems typically remain in place until construction is completed, or until permanent lighting is installed. For example, conventional temporary lighting systems are typically removed (by electrical contractors) before sheetrock installation, but they often must be reinstalled once the sheetrock is in place. The permanent lighting system (e.g. including permanent fixtures) is installed during the final stage of construction (e.g., the trim stage) after the building is painted. Once the permanent lighting system is installed and connected to permanent electrical service, the temporary lighting system is decommissioned and removed from the construction site. Consequently, electrical contractor personnel must arrange to be present at several different stages of the construction project. Such three-stage installation process (install/remove/install) is very labor and material intensive.

It would be beneficial to utilize previously-installed components of a lighting system to provide specified illumination, both during and following a construction project.

### BRIEF SUMMARY

In one or more embodiments disclosed herein, a method includes: connecting a light source to a permanent wiring system of a construction project; connecting a protective cover to the light source; and after the light source has been utilized to provide a first specified illumination during one or more stages of the construction project, connecting a cover plate to the light source, wherein the light source remains connected to the permanent wiring system during the one or more stages of the construction project and while connecting the cover plate to the light source.

In one or more embodiments disclosed herein, a temporary-to-permanent lighting system includes: a light source configured to fasten to an electrical outlet box of a permanent wiring system of a construction project; a protective cover configured to connect to the light source with one or more first quick-connect fastening mechanisms; and a cover plate configured to connect to the light source with one or more second quick-connect fastening mechanisms.

In one or more embodiments disclosed herein, a method of utilizing a temporary-to-permanent lighting system includes: fastening a light source of the temporary-to-permanent lighting system to an electrical outlet box of a permanent wiring system of a construction project; connecting a protective cover to the light source with one or more first quick-connect fastening mechanisms so that the temporary-to-permanent lighting system provides a first specified illumination (e.g., at least 5 foot-candles for general construction, or at least 10 foot-candles for in plants or shops) during one or more stages of the construction project; and after the one or more stages of the construction project, connecting a cover plate to the light source with one or more second quick-connect fastening mechanisms so that the temporary-to-permanent lighting system to provides a second specified illumination (e.g., at least 3 foot-candles for living room areas, or at least 9 foot-candles for kitchen areas) subsequent to the construction project.

### BRIEF DESCRIPTION OF THE DRAWINGS

So that the manner in which the features of the present disclosure can be understood in detail, a more particular description of the disclosure may be had by reference to embodiments, some of which are illustrated in the appended drawings. It is to be noted, however, that the appended drawings illustrate only exemplary embodiments and are therefore not to be considered limiting of its scope, which may apply to other equally effective embodiments.

FIG. 1 illustrates a temporary lighting system.

FIG. 2 illustrates another temporary lighting system.

FIG. 3A illustrates a temporary-to-permanent lighting system, according to embodiments disclosed herein.

FIG. 3B illustrates further details of the temporary-to-permanent lighting system of FIG. 3A.

FIG. 4 illustrates an exemplary method for utilizing a temporary-to-permanent lighting system, according to embodiments disclosed herein.

### DETAILED DESCRIPTION

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. If there is any conflict in the usages of a word or term in this specification and one or more patent or other documents that may be incorporated herein by reference, the definitions that are consistent with this specification should be adopted for the purposes of understanding this disclosure.

This disclosure generally relates to electrical wiring installations methods and apparatuses, and, at least in some embodiments, to novel equipment for installation and/or finishing of lighting systems, for example, for new construction and/or renovation projects, such as for multifamily residential housing, and associated methods of use of such equipment.

In the construction industry, electrical contractors are typically responsible for installation, maintenance, and removal of temporary lighting systems utilized during construction. Electrical contractors are also typically responsible for installation of permanent lighting systems utilized following the construction project. These responsibilities are commensurate with the training and certification of the electrical contractors. Consequently, the electrical contractors are specialized workers who attend the construction site only for the purposes of installation, maintenance, and removal of the temporary and/or permanent lighting systems.

Some embodiments of this disclosure may advantageously utilize previously-installed components of a lighting system to provide specified illumination of both during and following a construction project. For example, a temporary-to-permanent fixture may be installed during the rough-in stage of a construction project, and then, with a minor update at trim stage, serve as the fixture for the permanent lighting system. Unlike traditional temporary lighting systems, a temporary-to-permanent fixture does not need to be removed. Thus, the three-stage installation process (install/remove/install) reduces to a one- or two-stage installation process. Thus, temporary-to-permanent fixtures, as disclosed herein, may significantly reduce the labor costs during the trim stage of a construction project. The disclosed temporary-to-permanent lighting systems may eliminate the need for temporary lighting systems all together, by allowing a portion of the permanent fixture to serve as a temporary lighting system during construction.

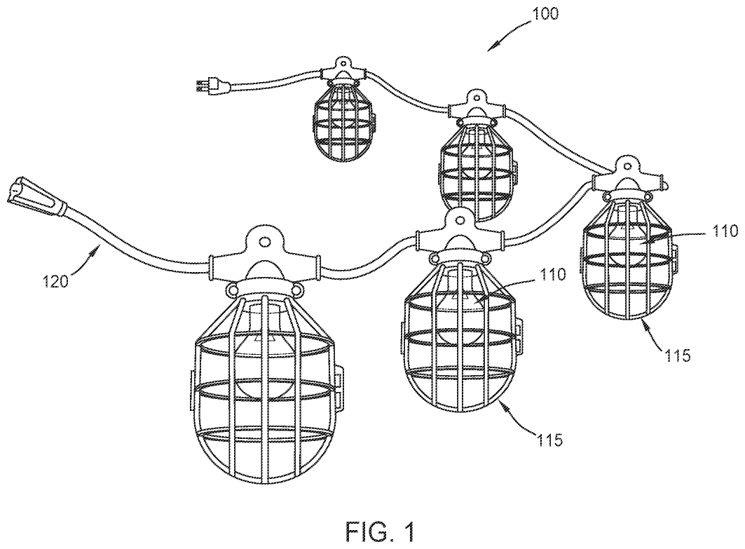

FIG. 1 illustrates a traditional temporary light string 100 that is appropriate for use as a temporary lighting system. As illustrated, the temporary light string 100 includes one or more (five as illustrated) protected light sources 110. As illustrated, the light sources 110 are each protected by a cage 115. Also as illustrated, each of the light sources 110 is attached to (e.g., powered by) an electrical cable system 120. It should be appreciated that components of temporary light strings may vary from those illustrated. For example, the light sources 110 could be incandescent, neon, LED, etc. The protection of each light source could be a wire or plastic cage, a glass or clear plastic shield, etc. The light sources may be powered by one or more electrical cables, fiber optic cables, or wireless power systems. Such temporary light strings are typically installed in dim areas of a construction site to provide specified illumination. Typically, the temporary light strings may be powered by the onsite temporary electric service.

Temporary lighting systems, such as temporary light string 100, can add significant costs to a construction project. Components of the temporary light string may be damaged at the construction site. In some instances, the damaged components may be replaced before completion of the construction project, duplicating previously-assessed charges. Additional charges related to temporary lighting systems include materials charges, logistics, storage, installation, maintenance, removal, transportation, repair/replacement, etc.

Heretofore, temporary lighting systems, such as temporary light string 100, would ultimately be removed and replaced with a permanent lighting system. For some projects, temporary lighting systems may be installed and removed multiple times during the course of construction. For example, due to timing of sheetrock installation, cabinet finishing, painting, appliance installation, etc., the temporary lighting system may obstruct work one day, while being necessary for work the following day. Removal and reinstallation of temporary lighting systems are labor intensive activities, requiring attendance of an electrical contractor at the construction site. Thus, removal and reinstallation of temporary lighting systems increases construction costs substantially for larger projects, such as multifamily residential construction.

Construction costs may also be impacted by theft of temporary lighting systems. By their very nature, temporary lighting systems tend to be portable, light weight, accessible, and not fixed or secured in place. Typically, temporary lighting systems, such as temporary light string 100, are simply hung from ceilings or walls, and are not fastened in place using screws or other hardware. Thus, no tools are required to uninstall the temporary lighting systems, making them susceptible to opportunistic theft. Alternatively, mounted or affixed temporary lighting systems must be removed after completion of construction. Removal of a mounted or affixed temporary lighting systems is labor intensive, and the high labor cost associated with attaching and detaching every temporary lighting system is often unacceptable.

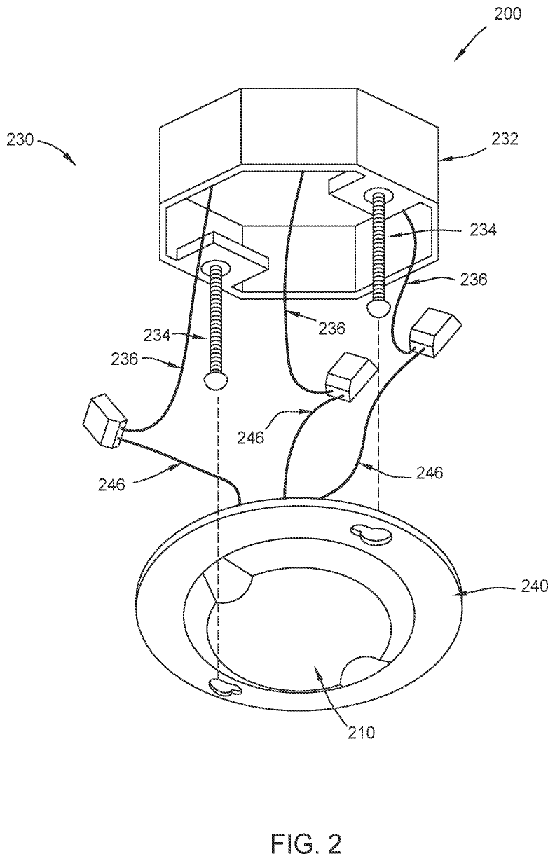

FIG. 2 illustrates a semi-permanent lighting system 200 that is appropriate for use as a temporary lighting system. Semi-permanent lighting system 200 includes a wiring system 230 connected to a temporary fixture 240. The temporary fixture 240 may include a light source 210 (or example, the light source 210 could be incandescent, neon, LED, etc.). As illustrated, the wiring system 230 includes a permanent outlet box 232, mounting screws 234, and supply and ground wires 236. Also as illustrated, the temporary fixture 240 is installed (e.g., with a tab-and-slot quick-connect) over the permanent outlet box 232 (e.g., electrically coupling supply and ground wires 236 with fixture wires 246). In contrast to the temporary light string 100 of FIG. 1, semi-permanent lighting system 200 does not include temporary wires (such as electrical cable system 120) that might cause entanglement or obstruction, or potentially cause system failure. The temporary fixture 240 may fit the perimeter of an electrical outlet box (e.g., permanent outlet box 232). As such, the temporary fixture 240 may remain in place during most stages of construction, including sheetrock and/or paint stages. However, temporary fixture 240 does not provide complete contaminant protection to light source 210. By remaining in place, light source 210 may be subject to exposure to contaminants, such as dirt, dust, plaster, and/or paint, especially during the trim stage of the construction project. Often, the contaminant build-up will be such that light source 210 will fail to provide sufficient lighting to meet regulatory standards.

Semi-permanent lighting system 200 allows the permanent wiring system of the building under construction to be used for distribution of electricity to the temporary fixtures of the temporary lighting system. For example, at the beginning of the electrical rough-in stage of construction, temporary fixtures (such as temporary fixture 240) may be installed along with the permanent wiring system (such as wiring system 230) of the construction project. The permanent wiring system is then connected to temporary electric service on site to power the temporary lighting system.

However, as with the temporary light string 100 of FIG. 1, the temporary fixtures 240 of FIG. 2 must still be removed and replaced with permanent fixtures in the final trim stage of construction. It should be appreciated that construction sites tend to be dirty environments. Contaminants, such as dirt, dust, plaster, and/or paint, may build up on temporary lighting systems. Thus, the temporary fixtures (such as temporary fixture 240) may not fully protect the permanent wiring system (such as wiring system 230), which may need cleaning, repair, and/or replacement before the permanent fixtures can be installed. Also, the aforementioned concerns associated with temporary string lights (e.g. logistics, overhead, damage, theft, etc.) are not fully addressed with this semi-permanent lighting system 200.

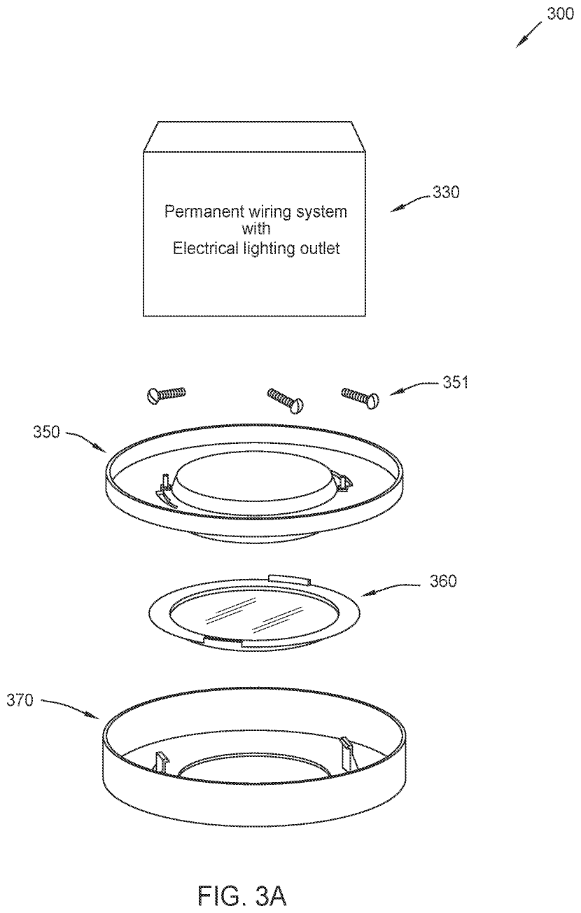

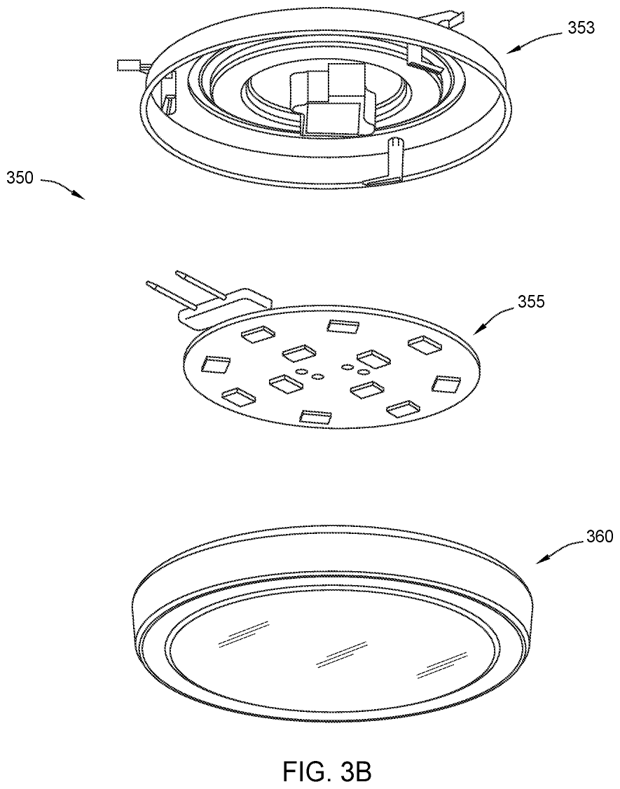

FIG. 3A illustrates a temporary-to-permanent lighting system 300, according to embodiments disclosed herein. In some embodiments, temporary-to-permanent lighting system 300 may include a three-part design. For example, temporary-to-permanent lighting system 300 may include a light source 350 (e.g., an LED lens unit), a protective cover 360, and a cover plate 370. The temporary-to-permanent lighting system 300 may be connected to (e.g., electrically connected to and/or powered by) permanent wiring system 330, for example connection may be made early in the rough-in stage of a construction project.

Light source 350 may fit an electrical outlet box. In some embodiments, the light source 350 may utilize device screws as fasteners. For example, the light source 350 may be mounted and/or fastened to an electrical outlet box of permanent wiring system 330. For example, the light source 350 may be mounted and/or fastened using screws 351. Consequently, and in contrast to temporary fixture 240, light source 350 may be mounted and/or fastened such that light source 350 may remain in place subsequent to the construction project (e.g., for the life of the building).

As illustrated in FIG. 3B, in some embodiments, the light source 350 may include a light source base 353 and one or more light bulbs 355 (e.g., LED light bulbs) that are readily separable from the light source base 353. For example, the one or more light bulbs 355 may be replaceable without replacing the light source base 353. In some embodiments, the light source 350 may include one or more light bulbs that are integrated into the light source base. In some embodiments, light source 350 may include a battery power source. For example, the battery power source may provide power to light source 350 if power from permanent wiring system 330 fails. In some embodiments, the battery power source may be rechargeable. For example, permanent wiring system 330 may provide power for recharging the battery power source. In some embodiments, light source 350 may include a translucent sheath opposite light source base 353, thereby covering the one or more light bulbs 355. For example, the translucent sheath may be disposed between the one or more light bulbs 355 and the protective cover 360 when the protective cover 360 is connected to light source 350. In some embodiments, light source base 353 and the translucent sheath may together form a housing for the one or more light bulbs 355.

The protective cover 360 may protect the light source 350, for example against contaminants, such as dirt, dust, plaster, and/or paint. The protective cover 360 may keep the light source 350 sufficiently clean throughout construction stages, such as sheetrock and/or paint stages. In some embodiments, the protective cover 360 may be washable and/or disposable. In some embodiments, the protective cover 360 may be made of hard plastic, flexible plastic, glass, frosted glass, or some other translucent, transparent, semi-transparent, or semi-opaque material. In some embodiments, the protective cover 360 may be a transparent/translucent peel-off (e.g., sticker-type) protector. In some embodiments, protective cover 360 may include multiple protective layers, such as peel-off protective film. In some embodiments, a portion and/or all of protective cover 360 may be disposable to allow for quick removal of contaminants, such as dirt, dust, plaster, and/or paint, etc. In some embodiments, protective cover 360 may include a silicone or other coating to repel dirt. In some embodiments, protective cover 360 may carry a low electrostatic charge to repel dirt.

Protective cover 360 may be connected to light source 350. In some embodiments, protective cover 360 may utilize one or more quick-connect fastening mechanisms to connect to light source 350. For example, a threaded coupling and/or a tab-and-slot coupling may be utilized as a fastening mechanism for connecting the protective cover 360 to the light source 350. As another example, chemical adhesion (e.g., glue), electrostatic adhesion, and/or vacuum adhesion may be utilized as a fastening mechanism. Such fastening mechanisms may eliminate the need for additional hardware and tools (such as device screws and screw drivers) to connect protective cover 360 to light source 350. In some embodiments, the light source 350 and the protective cover 360, connected together as one unit, may be connected to permanent wiring system 330.

The cover plate 370 may be connected to light source 350 and/or protective cover 360. In some embodiments, cover plate 370 may utilize a quick-connect fastening mechanism to connect to light source 350 and/or protective cover 360. For example, a threaded coupling and/or a tab-and-slot coupling may be utilized as a fastening mechanism for connecting the cover plate 370 to the light source 350 and/or protective cover 360. Such fastening mechanisms may eliminate the need for additional hardware and tools (such as device screws and screw drivers) to connect cover plate 370 to light source 350 and/or protective cover 360.

The cover plate 370, connected to light source 350 and/or protective cover 360, may serve as the permanent fixture subsequent to the construction project, providing specified illumination subsequent to the construction project. For example, the cover plate 370 may cover any sheetrock gaps and/or provide a finished appearance to meets the design requirements of a permanent fixture. For example, the cover plate 370 may have the appearance of chrome, silver, or gold-plated construction. The cover plate 370 may be constructed of durable materials, such as metal, wood, plastic, or rubber. In some embodiments, cover plate 370 may be opaque (e.g., to hide the holes, hardware, and/or imperfections of the installed device).

Temporary-to-permanent lighting system 300 may mitigate and/or resolve many issues inherent in temporary lighting systems (e.g., temporary light string 100 or semi-permanent lighting system 200). For example, by using the light source 350 with permanent wiring system 330 both during and following a construction project, overhead costs and logistics issues (purchasing, transportation, storage, protection, installation and removal) may be reduced or eliminated. As another example, since the light source 350 fits an electrical outlet box, the light source 350 may remain in place (e.g., connected to the permanent wiring system 330) throughout all construction stages, including sheetrock and painting. As another example, the protective cover 360 may reduce or eliminate contaminant build-up issues on temporary-to-permanent lighting system 300. As another example, temporary-to-permanent lighting system 300 may minimize or reduce any security and/or theft problems associated with conventional temporary lighting systems, since the light source 350 is installed and fastened onto the permanent wiring system 330 (e.g., using screws 351). This is in contrast to the conventional temporary lighting systems which are hung from the ceiling (FIG. 1) or the outlet box (FIG. 2) without screws and/or tools.

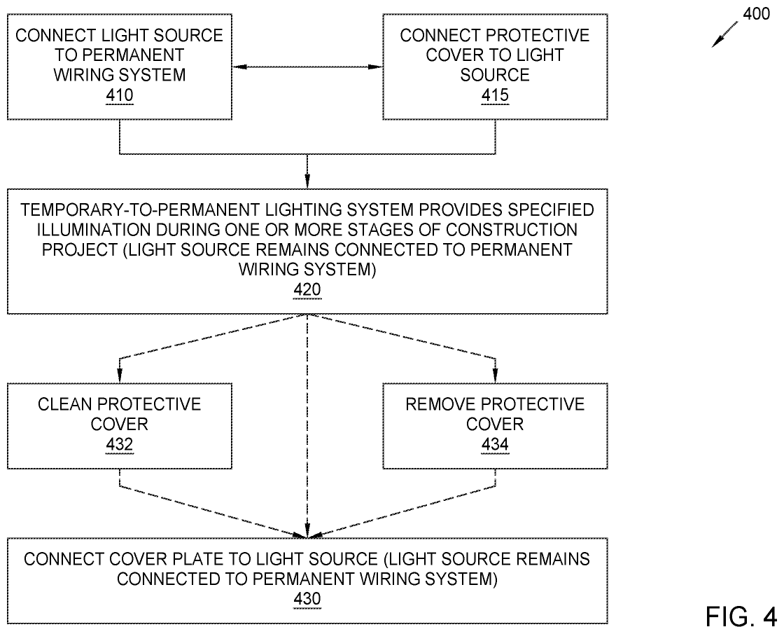

FIG. 4 illustrates a method 400 of utilizing a temporary-to-permanent lighting system (e.g., temporary-to-permanent lighting system 300) for a construction project. In some embodiments, the method 400 begins at box 410 with connecting a light source (e.g., light source 350) to a permanent wiring system (e.g., permanent wiring system 330). In such embodiments, the method continues at box 415 with connecting a protective cover (e.g., protective cover 360) to the light source. In some embodiments, the method 400 begins at box 415 with connecting a protective cover (e.g., protective cover 360) to a light source (e.g., light source 350). In such embodiments, the method continues at box 410 with connecting the light source to a permanent wiring system (e.g., permanent wiring system 330). It should be appreciated that method 400 may include boxes 410 and 415 in either order. In some embodiments, the actions identified in boxes 410 and 415 are accomplished early in a construction project, such as during the rough-in stage.

The method 400 may continue at box 420 where the temporary-to-permanent lighting system is utilized to provide a first specified illumination during one or more stages of the construction project (e.g., at least 5 foot-candles for general construction, or at least 10 foot-candles for in plants or shops). For example, the temporary-to-permanent lighting system may provide the specified illumination during the sheetrock and/or paint stages. Note that the light source remains connected to permanent wiring system during the one or more stages of the construction project.

The method 400 may continue at box 430 with connecting a cover plate (e.g., cover plate 370) to the light source while the light source remains connected to the permanent wiring system. For example, at the trim stage of the construction project, after sheetrock installation and/or paint projects are completed, the cover plate may be connected to the light source. The temporary-to-permanent lighting system may then be utilized to provide a second specified illumination (e.g., at least 3 foot-candles for living room areas, or at least 9 foot-candles for kitchen areas) subsequent to the construction project. The second specified illumination may be greater than or less than the first specified illumination. In some embodiments, the method 400 may first proceed to box 432 with cleaning the protective cover prior to connecting the cover plate to the light source at box 430. In some embodiments, the method 400 may first proceed to box 434 with removing the protective cover prior to connecting the cover plate to the light source at box 430. In all embodiments, the light source remains connected to the permanent wiring system during the various stages of the construction project and while the cover plate is connected to the light source.

While the foregoing is directed to embodiments of the present disclosure, other and further embodiments of the disclosure may be devised without departing from the basic scope thereof, and the scope thereof is determined by the claims that follow.

1. A method comprising:
connecting a light source to a permanent wiring system of a construction project;
connecting a protective cover to the light source; and
after the light source has been utilized to provide a first specified illumination during one or more stages of the construction project, connecting a cover plate to the light source, wherein the light source remains connected to the permanent wiring system during the one or more stages of the construction project and while connecting the cover plate to the light source.

2. The method of claim 1, wherein the connecting the light source to the permanent wiring system precedes connecting the protective cover to the light source.

3. The method of claim 1, wherein the connecting the light source to the permanent wiring system comprises fastening the light source to an electrical outlet box of the permanent wiring system.

4. The method of claim 1, wherein the connecting the protective cover to the light source utilizes one or more quick-connect fastening mechanisms.

5. The method of claim 1, further comprising cleaning the protective cover.

6. The method of claim 1, further comprising removing the protective cover.

7. The method of claim 1, wherein the connecting the cover plate to the light source utilizes one or more quick-connect fastening mechanisms.

8. The method of claim 1, wherein the light source with the connected cover plate is capable of providing a second specified illumination subsequent to the construction project.

9. The method of claim 1, wherein the construction project comprises multifamily residential housing.

10. The method of claim 1, wherein the stages of the construction project comprise one or more of:
sheetrock installation; and
painting.

11. The method of claim 1, wherein a temporary-to-permanent lighting system comprises the light source, the protective cover, and the cover plate.

12. A temporary-to-permanent lighting system comprising:
a light source configured to fasten to an electrical outlet box of a permanent wiring system of a construction project;
a protective cover configured to connect to the light source with one or more first quick-connect fastening mechanisms; and
a cover plate configured to connect to the light source with one or more second quick-connect fastening mechanisms.

13. The temporary-to-permanent lighting system of claim 12, wherein the light source comprises an LED lens unit.

14. The temporary-to-permanent lighting system of claim 12, wherein the light source comprises:
a light source base; and
one or more light bulbs.

15. The temporary-to-permanent lighting system of claim 12, wherein the light source fastens to the electrical outlet box with screws.

16. The temporary-to-permanent lighting system of claim 12, wherein the first quick-connect fastening mechanisms comprise one or more of:
a threaded coupling;
a tab-and-slot coupling;
a chemical adhesion;
an electrostatic adhesion; and
a vacuum adhesion.

17. The temporary-to-permanent lighting system of claim 12, wherein the second quick-connect fastening mechanisms comprise one or more of:
a threaded coupling; and
a tab-and-slot coupling.

18. A method of utilizing a temporary-to-permanent lighting system, the method comprising:
fastening a light source of the temporary-to-permanent lighting system to an electrical outlet box of a permanent wiring system of a construction project;
connecting a protective cover to the light source with one or more first quick-connect fastening mechanisms so that the temporary-to-permanent lighting system provides a first specified illumination during one or more stages of the construction project; and
after the one or more stages of the construction project, connecting a cover plate to the light source with one or more second quick-connect fastening mechanisms so that the temporary-to-permanent lighting system provides a second specified illumination subsequent to the construction project.

19. The method of claim 18, wherein the light source remains fastened to the electrical outlet box during the one or more stages of the construction project and while connecting the cover plate to the light source.

20. The method of claim 18, wherein:
the construction project comprises multifamily residential housing, and
the stages of the construction project comprise one or more of:
sheetrock installation; and
painting.
